(19) United States
(12) Patent Application Publication
(10) Pub. No.: US 2021/0159486 A1
(43) Pub. Date: May 27, 2021

(54) METHOD FOR PREPARING ANODE AND SECONDARY BATTERY COMPRISING THE ANODE PREPARED THEREBY

(71) Applicant: SK Innovation Co., Ltd., Seoul (KR)

(72) Inventors: Da Bin CHUNG, Daejeon (KR); Kwang Ho JEONG, Daejeon (KR)

(21) Appl. No.: 17/039,509

(22) Filed: Sep. 30, 2020

(30) Foreign Application Priority Data
Nov. 27, 2019 (KR) 10-2019-0154596

(51) Int. Cl. H01M 4/139; H01M 4/62; H01M 4/04; H01M 10/0525

(52) U.S. Cl. CPC H01M 4/139; H01M 4/622; H01M 2004/027; H01M 4/0435; H01M 10/0525; H01M 4/0404

(57) ABSTRACT

The present disclosure relates to a secondary battery including a cathode formed on a cathode current collector and at least one surface of the cathode current collector and comprising a cathodic active material and a binder; an anode formed on an anode current collector and at least one surface of the anode current collector and comprising a anodic active material and a binder; and a separation film disposed between the cathode and the anode, wherein surface roughness (Ra) of the anode is 1.0 μm or less, and a standard deviation of the surface roughness of the anode is 0.05 or less. An anode prepared according to an example embodiment of the present disclosure has improved surface roughness, and accordingly, electrical resistance of a lithium ion secondary battery can be reduced, and further, long lifespan characteristics are improved.

### CROSS-REFERENCE TO RELATED APPLICATION(S)

This application claims benefit of priority to Korean Patent Application No. 10-2019-0154596 filed on Nov. 21, 2019, in the Korean Intellectual Property Office, the disclosure of which is incorporated herein by reference in its entirety.

### BACKGROUND

The present disclosure relates to a method for preparing an anode and a secondary battery comprising an anode prepared thereby, more specifically to a method for preparing an anode having improved surface uniformity and capable of having improved long lifespan characteristics, and a secondary battery comprising the anode prepared thereby.

Recently, the number of devices using electricity as an energy source has increased. As there is an expansion of application fields for devices, such as smartphones, camcorders, notebook PCs, electric vehicles, and the like, using electricity, interest in electric storage devices using electrochemical devices is increasing. Among various electrochemical devices, lithium secondary batteries, which are capable of being charged and discharged and which have high operating voltages and remarkably high energy density, are drawing attention.

Main elements of such a lithium secondary battery are a cathode, an anode, an electrolyte and a separating membrane. The cathode and the anode provide a location for an oxidation reduction reaction to occur, and the electrolyte serves to deliver lithium ions between the cathode and the anode, while the separation membrane electrically insulates the cathode and the anode, such that they do not come into contact with each other. According to an operational principle of a lithium ion battery, when lithium is oxidized to lithium ions in the anode during discharging, the lithium ions move to the cathode through an electrolyte, and electrons generated therefrom move to the cathode through outside wires. The lithium ions moved from the anode are inserted into the cathode and accept the electrons, thereby causing a reduction reaction. Contrary thereto, an oxidation reaction takes place in the cathode during charging, and a reduction reaction takes place in the anode.

Meanwhile, non-uniform loading and density of the electrode may cause partial distortion of the anode and the cathode during battery preparation, which may lead to non-uniform charging and discharging and may affect long lifespan characteristics of the battery. It is important to manufacture an electrode having a uniform surface to secure the long lifespan characteristics of a battery.

### SUMMARY

In consideration of the above problems, the present disclosure is to provide a method for preparing an anode capable of having enhanced lifespan characteristics and reduced electrical resistance of a lithium ion secondary battery by improving surface roughness of the anode, and a lithium ion secondary battery including the anode.

According to an aspect of the present disclosure, a secondary battery is provided, the secondary battery including a cathode formed on a cathode current collector and at least one surface of the cathode current collector and comprising a cathodic active material and a binder; an anode formed on an anode current collector and at least one surface of the anode current collector and comprising a anodic active material and a binder; and a separation film disposed between the cathode and the anode, wherein surface roughness (Ra) of the anode is 1.0 μm or less, and a standard deviation of the surface roughness of the anode is 0.05 or less.

The standard deviation of the surface roughness of the anode may be 0.03 to 0.05.

The binder included in the anode may include a cellulose-based polymer.

The cellulose-based polymer may be one or more selected from methyl cellulose, ethyl cellulose, hydroxyethyl cellulose, benzyl cellulose, triethyl cellulose, cyanoethyl cellulose, carboxymethylcellulose (CMC), carboxyethyl cellulose, aminoethyl cellulose, nitrocellulose, cellulose ether, and carboxymethyl cellulose sodium salt (CMCNa).

A weight average molecular weight of the binder included in the anode may be 800,000 to 5,000,000.

The secondary battery may include the binder in an amount of 0.6 wt % to 2.0 wt % based on a total weight of an anode mixture layer.

The binder included in the anode may include carboxymethylcellulose having a substitution degree (DS) of a metal ion is 0.6 to 1.5.

The metal ion may be one or more selected from Na⁺, K⁺ and Li⁺.

The binder in the cathode may be one or more selected from carboxymethylcellulose (CMC), styrene butadiene rubber (SBR), polyvinylidenefluoride, polyvinylalcohol, starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM and a fluoro rubber.

According to another aspect, a method for preparing an anode is provided, the method including grinding a binder; preparing a mixture solution comprising less than 50 microgels per area of 10.2 cm² by mixing the ground binder and water; preparing an anode slurry by mixing an anodic active material into the mixture solution; forming an anode mixture layer by applying the anode slurry onto an anode current collector and drying the same; and rolling the anode current collector on which the anode mixture layer is formed.

Surface roughness of the anode mixture layer formed by the applying and drying processes may be 1.8 μm or less, and a standard deviation of the surface roughness may be 0.15 or less.

Surface roughness of the anode mixture layer after rolling may be 1.0 μm or less, and a standard deviation of the surface roughness may be 0.05 or less.

A standard deviation of the surface roughness of the anode mixture layer after rolling may be 0.03 to 0.05.

The binder-grinding process may be performed for 10 minutes to 120 minutes.

After the anode slurry is prepared, the method may further include filtering the anode slurry.

A number of microgels in the mixture solution is less than 30 per area of 10.2 cm².

### DETAILED DESCRIPTION

Hereinbelow, preferred embodiments of the present disclosure will be described with reference to various example embodiments. However, the present disclosure can be embodied in various forms, and is not limited to the embodiments below.

The present disclosure relates to a method for preparing an anode and a secondary battery comprising the anode prepared thereby, more specifically to a method for preparing an anode having improved surface uniformity and capable of having improved long lifespan characteristics, and a secondary battery comprising the anode prepared thereby.

A secondary battery inevitably repeats charging and discharging. Surface roughness of an electrode of the secondary battery, particularly of an anode is non-uniform, Li-plating intensively occurs in a particular site having high density when there is a density difference in the electrode, thereby first deteriorating the electrode. This may result in a problem that long lifespan characteristics of the electrode are deteriorated. The present inventors discovered that surface roughness of an anode and a standard deviation thereof can be improved in the case in which a number of microgels included in an anode slurry is controlled during manufacturing of the anode, thereby completing the present disclosure. Meanwhile, the term “gel” refers to a state in which 99% of a weight is composed of liquid and is immobilized due to surface tension therebetween and a network structure of a polymer containing a small amount of gelling materials. Gels are mostly liquid and thus have a density similar to liquids but remain agglomerated as solids. As used herein, the term “microgel” is understood as a substance, particle or agglomerate having a size of 20 μm or less, specifically 100 nm to 20 μm, which can be formed of insoluble ingredients or a binder undissolved when the binder is dispersed or dissolved in a solvent.

According to an aspect, a method for preparing an anode is provided, the method including grinding a binder; preparing a mixture solution comprising less than 50 microgels per area of 10.2 cm² by mixing the ground binder and water; preparing an anode slurry by mixing an anodic active material into the mixture solution; forming an anode mixture layer by applying the anode slurry onto an anode current collector and drying the same; and rolling the anode current collector on which the anode mixture layer is formed.

The binder is an ingredient serving to assist adhesion between a conductive material and an anodic active material consisting of the anode mixture layer, and/or between the anode mixture layer and the anode current collector. It is preferable that in the present disclosure, a cellulose-based polymer be used as the binder.

The cellulose-based polymer is not particularly limited, but may include, for example, carboxymethylcellulose (CMC), styrene butadiene rubber (SBR), polyvinylidenefluoride, polyvinylalcohol, starch, hydroxypropylcellulose, regenerated cellulose, polyvinylpyrrolidone, tetrafluoroethylene, polyethylene, polypropylene, ethylene-propylene-diene terpolymer (EPDM), sulfonated EPDM and a fluoro rubber.

Meanwhile, it is preferable that the binder has a weight average molecular weight (Mw) of 800,000 to 5,000,000. When the weight average molecular weight is less than 800,000, viscosity may be too low to coat the slurry in an equivalent amount, whereas the weight average molecular weight of greater than 5,000,000 makes it difficult to dissolve CMC, thereby increasing a number of the microgels. Meanwhile, the expression “the weight average molecular weight” refers to a weight average molecular weight measured by gel permeation chromatography (GPC).

According to a preferred example embodiment, the binder may include a metal ion substitution. More preferably, the binder may include CMC having a substitution degree (DS) of the metal ion of 0.6 to 1.5. The metal ion may be one or more selected from Na⁺, K⁺ and Li⁺, preferably a Na⁺ ion. Use of the binder having a metal ion substitution may serve to reduce resistance based on the binder itself during repetition of charging and discharging, thereby further improving ion mobility. Meanwhile, when the substitution degree is 0.6 or less, a solubility of a solvent is too low that the binder is not appropriate for dispersion of the anodic active material. In contrast, a molecular weight of CMC, the binder, needs to be reduced for the substitution degree (DS) of 1.5 or more, viscosity of an anode slurry, which is finally prepared, is lowered, causing a problem in phase stability. Hereinafter, a case, in which carboxymethyl cellulose having a sodium ion substitution (CMCNa) is used as a binder, will be described.

When CMC is mixed in water, preferably distilled water, CMC particles are not entirely dissolved when not sufficiently dispersed, and the microgels, undissolved substances, remain in the mixture solution. The microgels are not removed even during preparation of the slurry and causes agglomeration. The microgels may raise a problem of non-uniform electrode surface after coating and may induce a partial density difference in the electrode after rolling. According to a preferred example embodiment, a number of microgels included in the mixture solution is controlled to be less than 50 per area of 10.2 cm² to make surface roughness of the anode uniform. Meanwhile, the number of the microgels included in the mixture solution can be measured by coating the mixture solution on a substrate film of a unit area and measuring a number of microgels formed on the coated layer. Specifically, the number of the microgels can be measured by the following method: forming a circle having a diameter of 36 mm on an overhead projector film (OHP) and coating the circle with the solution in a thickness of 100 μm followed by observing with the naked eye to measure the number of the microgels formed on the coated layer.

In this regard, it is preferable that the binder be ground before preparing the mixture solution by mixing the binder and water. The grinding process is not particularly limited as long as a method thereof is known in the art. For example, the grinding process may be carried out through mechanical milling, and the mechanical milling may be carried out using a roll-mill, a ball-mill, a cone-mill, a high energy ball mill, a planetary mill, a stirred ball mill, a vibrating mill or a jet-mill.

It is preferable that the binder grinding be performed for 10 minutes to 120 minutes. A grinding time of less than 10 minutes is too short to sufficiently and uniformly grind the binder, whereas that exceeding 120 minutes may cause aggregation between particles due to a significantly increased surface area of the binder particle.

The anodic active material is mixed in the mixture solution to prepare the anode slurry. In this case, it is preferable that the binder be included in an amount of 0.6 wt % to 2.0 wt % based on a total weight of the anode mixture layer. When the amount is less than 0.6 wt %, viscosity of the slurry is low, thus making it difficult to coat the slurry and achieve adhesion as a binder, whereas when the amount is greater than 2.0 wt %, resistance in a cell increases, leading to a problem that electrical characteristics are not expressed.

If necessary, the method for preparing an anode may further include filtering the anode slurry after the anode slurry is prepared and applied onto the anode current collector and before preparing the anode mixture layer.

The anode mixture layer may be prepared by applying the anode slurry onto the anode current collector and drying the same. Applying, drying and rolling processes conventionally used in the art may be performed. For example, a coating method using a slot die in addition to Mayer bar coating process, gravure coating process, dip coating process, or a spray coating process may be used for the applying process. The drying process can be performed in a dry atmosphere at room temperature The rolling process can be performed by rolling the anode mixture layer formed on the anode current collector by applying and drying through a metal rolling roll of calendaring equipment.

Meanwhile, surface roughness of the anode mixture layer formed through the applying and drying processes before the rolling may be 1.8 μm or less, and a standard deviation of the surface roughness of the anode mixture layer may be 0.15. Further, surface roughness of the anode mixture layer after the rolling process may be 1.0 μm or less, a standard deviation of the surface roughness of the anode mixture layer may be 0.05, preferably 0.03 to 0.05.

Conventionally, surface roughness of an anode mixture layer formed through applying and drying processes is greater than 2.5 μm, and a standard deviation thereof is 0.2 or above. In such a case in which a roughness of an anode surface is non-uniform and there is a density difference in an electrode, Li-plating intensively occurs in a particular site having high density, and as a result, long lifespan characteristics are deteriorated. According to an example embodiment, a number of the microgels are controlled to be less than 50 per area of 10.2 cm² by to significantly improve surface roughness of the anode mixture layer and a standard deviation thereof, thereby improving the long lifespan characteristics of the battery.

In addition, not only surface roughness of the anode mixture layer after a rolling process, which will be described later, is 1.0 μm, but also a standard deviation thereof may be 0.05, preferably 0.03 to 0.05. That is, according to the present disclosure, the surface roughness of the anode mixture layer before the rolling is excellent, a special treatment for improving the surface roughness is not required, and the standard deviation is as low as 0.05 or less.

According to the example embodiment above, a secondary battery is provided, the secondary battery including a cathode formed on a cathode current collector and at least one surface of the cathode current collector and comprising a cathodic active material and a binder; an anode formed on an anode current collector and at least one surface of the anode current collector and comprising a anodic active material and a binder; and a separation film disposed between the cathode and the anode, wherein surface roughness (Ra) of the anode is 1.0 μm or less, and a standard deviation of the surface roughness of the anode is 0.05 or less.

Meanwhile, a cathode of the secondary battery may include a cathode mixture layer formed on a cathode current collector and at least one surface thereof. As the cathode current collector, a thin film formed of aluminum, stainless steel or nickel, or a porous material having the shape of a net, mesh, or the like, may be used. Alternately, the cathode current collector may be coated with an oxidization-resistance metal or alloy coating film to prevent oxidation.

The cathodic active material included in the cathode mixture layer is not particularly limited as long as a sufficient capacity is secured. For example, the cathodic active material may include at least one selected from the group consisting of lithium cobalt oxide, lithium nickel cobalt manganese oxide, lithium nickel cobalt aluminum oxide, lithium iron phosphate and lithium manganese oxide, but is not limited thereto. Any cathodic active material available in the art can be used.

The cathodic active material may be, for example, a compound represented by the following formula: LiₐA_{1-b}M_{b}D₂ (where 0.90≤a≤1.8, 0≤b≤0.5); LiₐE_{1-b}M_{b}O_{2-c}D_{c} (where 0.90≤a≤1.8, 0≤b≤0.5, 0≤c≤0.05); LiE_{2-b}M_{b}O_{4-c}D_{c} (where 0.90≤a≤1.80, 0≤c≤0.05); LiₐNi_{1-b-c}CO_{b}M_{c}D_{α} (where 0.90≤1.8, 0≤b≤0.5, 0≤c≤0.05, 0<α≤2); LiₐNi_{1-b-c}Co_{b}McO_{2-α}X_{α} (where 0.90≤a≤1.8, 0≤b≤0.5, 0≤c≤0.05, 0<α≤2); LiₐNi_{1-b-c}CO_{b}McO_{2-α}X₂ (where 0.90≤a≤1.8, 0≤b≤0.5, 0≤c≤0.05, 0<α<2); LiₐNi_{1-b-c}Mn_{b}M_{c}D_{α} (where 0.90≤a≤1.8, 0≤b≤0.5, 0≤c≤0.05, 0<α≤2); LiₐNi_{1-b-c}Mn_{b}M_{c}O_{2-α}X_{α} (where 0.90≤a≤1.8, 0≤b≤0.5, 0≤c≤0.05, 0<α<2); LiₐNi_{1-b-c}Mn_{b}M_{c}O_{2-α}X₂ (where 0.90≤a≤1.8, 0≤b≤0.5, 0≤c≤0.05, 0<α<2); LiₐNi_{b}E_{c}GdO₂ (where 0.90≤a≤1.8, 0≤b≤0.9, 0≤c≤0.5, 0.001≤d≤0.1); LiₐNi_{b}CO_{c}Mn_{d}GeO₂ (where 0.90≤a≤1.8, 0≤b≤0.9, 0≤c≤0.5, 0≤d≤0.5, 0.001≤e≤0.1); LiₐNiG_{b}O₂ (where 0.90≤a≤1.8, 0.001≤b≤0.1); LiₐCoG_{b}O₂ (where 0.90≤a≤1.8, 0.001≤b≤0.1); LiₐMnG_{b}O₂ (where 0.90≤a≤1.8, 0.001≤b≤0.1); LiₐMn₂G_{b}O₄ (where 0.90≤a≤1.8, 0.001≤b≤0.1); QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₃ (where 0≤f≤2); and LiFePO₄. In the above formula, A is Ni, Co, or Mn; M is Al, Ni, Co, Mn, Cr, Fe, Mg, Sr, V or a rare-earth element; D is O, F, S or P; E is Co or Mn; X is F, S or P; G is Al, Cr, Mn, Fe, Mg, La, Ce, Sr or V; Q is Ti, Mo or Mn; R is Cr, V, Fe, Sc or Y; J is V, Cr, Mn, Co, Ni or Cu.

Alternately, the cathodic active material may be LiCoO₂, LiMnₓO₂ₓ (where x=1 or 2), LiNi₂ₓMnₓO₂ₓ (where 0<x<1), LiNi_{1-x-y}COₓMn_{y}O₂ (where 0≤x≤0.5, 0≤y≤0.5), LiFePO₄, TiS₂, FeS₂, TiS₃ or FeS₃, but is not limited thereto.

If necessary, the cathode mixture layer may further include a conductive material. Any conductive material having conductivity without inducing a chemical change on a secondary battery is not particularly limited. For example, graphite such as natural graphite, artificial graphite, or the like; a carbon-based material such as carbon black, Ketjenblack, channel black, furnace black, lamp black, summer black, or the like; a conductive fiber such as a carbon fiber, a metal fiber, or the like; fluorinated carbon; powder of metal such as aluminum, nickel, or the like; a conductive whisky such as zinc oxide, potassium titanate, or the like; a metal oxide such as titan oxide, or the like; a conductive material such as a polyphenylene derivative, or the like; or the like.

Further, the cathode mixture layer may include a binder to improve adhesion of the active material with the conductive material, or the like, and the binder may be polyvinylidenefluoride, polyvinylalcohol, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM, a styrene butadiene rubber (SBR), a rubber, a fluoro rubber, various polymers, and the like, but is not limited thereto.

In the case of the anode, an anode current collector and an anode mixture layer formed thereon may be included. As the anode current collector, a thin film formed of copper, stainless steel, or nickel, or a porous material having the shape of a net, mesh, or the like, may be used. To prevent oxidation, the anode current collector may be coated with an oxidation-resistant metal or alloy coating.

Further, the anodic active material included in the anode mixture layer may include an anodic active material conventionally used. The anodic active material may include a carbonaceous material, silicon, a silicon oxide, a silicon-based alloy, a silicon-carbonaceous material composite, tin, a tin-based alloy, a tin-carbon composite, a metal oxide, or combinations thereof as well as lithium metal and/or lithium metal alloy.

Meanwhile, the anode may further include a conductive material. As the conductive material is described above, a detailed description thereof will be omitted here.

The separation film acts to prevent a short circuit between the cathode and the anode, and to provide a movement path of lithium ions. A polyolefin-based polymer such as polypropylene, polyethylene, polyethylene/polypropylene, polyethylene/polypropylene/polyethylene, polypropylene/polyethylene/polypropylene, or multilayers, microporous films, woven fabrics, nonwoven fabrics thereof, and other known separation films may be used as the separation film. Alternately, a film, such as a porous polyolefin film, coated with a resin having excellent stability may be used. When a solid electrolyte, such as a polymer, is used as the electrolyte, the solid electrolyte may act as the separation film.

Hereinafter, the present disclosure will be described in more detail with reference to the embodiments. However, the description of these embodiments is only intended to illustrate the practice in the present disclosure, but the scope of the present disclosure should not be limited by the embodiments.

### EXAMPLES

### Example 1

Carboxymethylcellulose (CMC; weight average molecular weight: 1,000,000), having a sodium substitution degrees of 0.75, was ground in a ball mill for 60 minutes. The ball used here was a 5-mm zirconia ball. The ground CMC was added to distilled water and mixed for 200 minutes to prepare a mixture solution containing 1.2 wt % CMC.

A circle of 36 mm in diameter was drawn on an OHP film and coated with the mixture solution in a thickness of 100 μm. A number of microgels formed on the coated layer was observed with the naked eye. This was repeated 5 times, and an average of the observed numbers of the microgels is shown in Table 1.

An anode slurry was prepared using the mixture solution containing the CMC. The anode slurry was prepared to include 96.3 wt % of graphite, 1.0 wt % of carbon black, 1.5 wt % of SBR and 1.2 wt % of CMC, and distilled water used as a solvent. The anode slurry was then applied on to a copper plate in a thickness of 265 v m and dried to prepare an anode mixture layer. After drying and before rolling, 60-cm anode mixture layer was collected in a machine direction and an Ra value thereof was measured using a roughness measurer ((Mitutoyo, SJ-310). The Ra value was measured 50 times, an average thereof and a range of a standard deviation thereof was calculated. The same procedure was performed for the case of rolling in a thickness of 125 v m to measure an average Ra value and a standard deviation range, which are shown in Table 1.

### Example 2

The same method used in Example 1 was used, except that the ball mill grinding process was performed for 100 minutes. An average of a number of observed microgels and a standard deviation range thereof were calculated and are shown in Table 1.

### Example 3

The same method used in Example 1 was used, except that the filtering process was performed using a mesh filter (1000 MESH) having a diameter of 20 μm. An average of a number of observed microgels and a standard deviation range thereof were calculated and are shown in Table 1.

### Comparative Example 1

The same method used in Example 1 was used, except that CMC, which is not ground, was used. An average of a number of observed microgels and a standard deviation range thereof were calculated and are shown in Table 1.

### Comparative Example 2

The same method used in Example 1 was used, except that CMC, which is not ground, was used, and an aqueous solution was mixed for 400 minutes. An average of a number of observed microgels and a standard deviation range thereof were calculated and are shown in Table 1.

### Comparative Example 3

The same method used in Example 3 was used, except that CMC, which is not ground, was used, and surface treatment of a prepared electrode was performed using a 3000-paper sand paper. An average of a number of observed microgels and a standard deviation range thereof were calculated and are shown in Table 1.

### Comparative Example 4

The same method used in Example 3 was used, except that CMC, which is not ground, was used. An average of a number of observed microgels and a standard deviation range thereof were calculated and are shown in Table 1.

TABLE 1

| | | | | Rₐ | | Rₐ | | Capacity |
|---|---|---|---|---|---|---|---|---|
| | | | Coated | Standard | Rolling | Standard | | retention |
| | Ball | Microgel | electrode | deviation | electroode | deviation | | ratio |
| | mill | (ea/10.2 | Rₐ | of coated | Rₐ | of rolling | DC-IR | (%, @ |
| | grinding | cm²) | (mm) | electrode | (mm) | electrode | (mΩ) | 500 cycle) |
| Ex 1 | 60 min | 20 ea | 1.741 | 0.10 | 0.609 | 0.045 | 1.250 | 96.5 |
| Ex 2 | 100 min | 10 ea | 1.727 | 0.11 | 0.582 | 0.041 | 1.215 | 96.9 |
| Ex 3 | 100 min | 5 ea | 1.589 | 0.11 | 0.546 | 0.036 | 1.212 | 97.6 |
| CE 1 | X | 100 ea | 3.116 | 0.31 | 0.655 | 0.063 | 1.297 | 89.7 |
| CE 2 | X | 100 ea | 2.812 | 0.31 | 0.646 | 0.065 | 1.293 | 89.5 |
| CE 3 | X | 100 ea | 2.715 | 0.43 | 0.653 | 0.079 | 1.291 | 89.1 |
| CE 4 | X | 80 ea | 2.711 | 0.39 | 0.642 | 0.088 | 1.288 | 91.8 |

Based on Table 1 above, as compared to Comparative Examples 1 to 4, Examples 1 to 3 were shown to have significantly low surface roughness and standard deviation of a coated electrode before rolling and after rolling. Further, DC-IR was shown to be reduced, and capacity retention ratios thereof were remarkably improved, confirming that long lifespan characteristics can be improved.

The anode prepared according to an example embodiment of the present disclosure has improved surface roughness, and accordingly has reduced electrical resistance of a lithium ion secondary battery. Further, long lifespan characteristics may be improved.

While the example embodiments have been shown and described above, it will be apparent to those skilled in the art that modifications and variations could be made without departing from the scope of the present disclosure as defined by the appended claims.

1. A secondary battery, comprising:
a cathode formed on a cathode current collector and at least one surface of the cathode current collector and comprising a cathodic active material and a binder;
an anode formed on an anode current collector and at least one surface of the anode current collector and comprising a anodic active material and a binder; and
a separation film disposed between the cathode and the anode,
wherein surface roughness (Ra) of the anode is 1.0 μm or less, and a standard deviation of the surface roughness of the anode is 0.05 or less.

2. The secondary battery of claim 1, wherein the standard deviation of the surface roughness of the anode is 0.03 to 0.05.

3. The secondary battery of claim 1, wherein the binder in the anode comprises a cellulose-based polymer.

4. The secondary battery of claim 1, wherein the cellulose-based polymer is one or more selected from methyl cellulose, ethyl cellulose, hydroxyethyl cellulose, benzyl cellulose, triethyl cellulose, cyanoethyl cellulose, carboxymethylcellulose (CMC), carboxyethyl cellulose, aminoethyl cellulose, nitrocellulose, cellulose ether, and carboxymethyl cellulose sodium salt (CMCNa).

5. The secondary battery of claim 1, wherein a weight average molecular weight of the binder in the anode is 800,000 to 5,000,000.

6. The secondary battery of claim 1, wherein the secondary battery comprises the binder in an amount of 0.6 wt % to 2.0 wt % based on a total weight of an anode mixture layer.

7. The secondary battery of claim 1, wherein the binder in the anode comprises carboxymethylcellulose having a substitution degree (DS) of a metal ion is 0.6 to 1.5.

8. The secondary battery of claim 7, wherein the metal ion is one or more selected from Na⁺, K⁺ and Li⁺.

9. The secondary battery of claim 7, wherein the binder in the cathode is one or more selected from carboxymethylcellulose (CMC), styrene butadiene rubber (SBR), polyvinylidenefluoride, polyvinylalcohol, starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM and a fluoro rubber.

10. A method for preparing an anode, comprising:
grinding a binder;
preparing a mixture solution comprising less than 50 microgels per area of 10.2 cm² by mixing the ground binder and water;
preparing an anode slurry by mixing an anodic active material into the mixture solution;
forming an anode mixture layer by applying the anode slurry onto an anode current collector and drying the same; and
rolling the anode current collector on which the anode mixture layer is formed.

11. The method of claim 10, wherein surface roughness of the anode mixture layer formed by the applying and drying processes is 1.8 μm or less, and a standard deviation of the surface roughness is 0.15 or less.

12. The method of claim 10, wherein surface roughness of the anode mixture layer after rolling is 1.0 μm or less, and a standard deviation of the surface roughness is 0.05 or less.

13. The method of claim 10, wherein a standard deviation of surface roughness of the anode mixture layer after rolling is 0.03 to 0.05.

14. The method of claim 10, wherein the binder-grinding process is performed for 10 minutes to 120 minutes.

15. The method of claim 10, further comprising filtering the anode slurry after preparing the anode slurry.

16. The method of claim 10, wherein a number of microgels in the mixture solution is less than 30 per area of 10.2 cm².
